(19) United States
(12) Patent Application Publication
(10) Pub. No.: US 2025/0368871 A1
(43) Pub. Date: Dec. 4, 2025

(54) POLYAMIDE ADHESIVE AND INSULATING COMPOSITE LAYER AND PREPARATION METHODS AND USES THEREOF

(71) Applicant: JIANGSU YOKE TECHNOLOGY CO., LTD, Wuxi (CN)

(72) Inventors: Jiaming Zhang, Wuxi (CN); Dongying Xie, Wuxi (CN); Heng Cao, Wuxi (CN); Qi Shen, Wuxi (CN); Yongzhi Jiang, Wuxi (CN); Hongfei Zhu, Wuxi (CN); Jianqing Ma, Wuxi (CN); Shengfei Weng, Wuxi (CN)

(21) Appl. No.: 19/299,293

(22) Filed: Aug. 13, 2025

Related U.S. Application Data
(63) Continuation of application No. PCT/CN2025/105536, filed on Jun. 30, 2025.

(30) Foreign Application Priority Data
Jun. 30, 2025 (CN) 202510886576.0

(51) Int. Cl. C09J 177/02; C08J 3/09; C08J 3/20; C08J 5/12; C08J 5/24; C08K 5/3445; C08K 5/544

(52) U.S. Cl. CPC C09J 177/02; C08J 3/095; C08J 3/203; C08J 5/121; C08J 5/124; C08J 5/244; C08K 5/3445; C08K 5/544; C08J 2377/02; C08J 2463/02

(57) ABSTRACT

A polyamide adhesive and an insulating composite layer, and preparation methods and uses thereof are provided. The polyamide adhesive includes the following raw materials in parts by weight: 70-90 parts of polyamide resin, 10-30 parts of bisphenol epoxy resin, 0.01-0.5 parts of an imidazole curing agent and 0.1-2 parts of a silane coupling agent. The preparation method includes: (1) weighing each raw material; (2) adding polyamide resin into an organic solvent, and stirring for dissolution; (3) adding bisphenol epoxy resin, imidazole curing agent and silane coupling agent, and stirring for reaction to obtain the product.

### CROSS REFERENCE TO RELATED APPLICATIONS

The present disclosure is a continuation application of international application PCT/CN2025/105536, which claims the priority to the Chinese patent application with the filing No. 202510886576.0, entitled “POLYAMIDE ADHESIVE AND INSULATING COMPOSITE LAYER AND PREPARATION METHODS AND USES THEREOF” and filed on Jun. 30, 2025 with the Chinese Patent Office, the contents of which are incorporated herein by reference in their entirety.

### TECHNICAL FIELD

The present disclosure relates to the technical field of adhesives, and more particularly to a polyamide adhesive and an insulating composite layer, and preparation methods and uses thereof.

### BACKGROUND ART

Liquefied natural gas (LNG for short) is a liquefied form of natural gas with methane as its main component and is recognized as the cleanest fossil energy on earth. It is colorless, odorless, non-toxic and non-corrosive, and has a volume approximately 1/625 that of the same volume of gaseous natural gas. The mass of the liquefied natural gas is only about 45% of that of the same volume of water. As China pays more and more attention to environmental protection, the demand for liquefied natural gas is increasing rapidly.

The storage and transportation of liquefied natural gas requires the use of thermal insulation materials that can maintain high thermal insulation performance, high strength and high stability in ultra-low temperature (−163° C.) environments. However, traditional polyamide materials usually shrink severely in ultra-low temperature environments and then fail to maintain their mechanical strength at room temperature.

Therefore, how to develop a new adhesive is a problem that a person skilled in the art needs to solve urgently.

### SUMMARY

In view of this, the object of the present disclosure is to provide a polyamide adhesive and an insulating composite layer, and preparation methods and uses thereof, so as to solve the deficiencies in the prior art.

In order to achieve the above object, the present disclosure adopts the following technical solution:
a polyamide adhesive, including the following raw materials in parts by weight: 70-90 parts of polyamide resin, 10-30 parts of bisphenol epoxy resin, 0.01-0.5 parts of an imidazole curing agent and 0.1-2 parts of a silane coupling agent.

Further, the polyamide adhesive includes the following raw materials in parts by weight: 85 parts of polyamide resin, 15 parts of bisphenol epoxy resin, 0.01 parts of the imidazole curing agent and 0.1 parts of the silane coupling agent.

Further, the polyamide resin is Nylon 6.

Further, the imidazole curing agent is at least one selected from the group consisting of 2-methylimidazole, 2-ethylimidazole, 2-phenylimidazole and 2-ethyl-4-methylimidazole, and preferably 2-methylimidazole.

Further, the silane coupling agent is 3-aminopropyltriethoxysilane.

A method for preparing the above-mentioned polyamide adhesive specifically includes the following steps:
(1) weighing each raw material according to the parts by weight of the above-mentioned polyamide adhesive;
(2) adding the polyamide resin into an organic solvent, and stirring for dissolution, to obtain a polyamide solution; and
(3) adding the bisphenol epoxy resin, the imidazole curing agent and the silane coupling agent into the polyamide solution, and stirring for reaction, to obtain the polyamide adhesive (with a solid content of 15%-30%).

Further, in the above step (2), the organic solvent is methanol; the mass ratio of the polyamide resin to the organic solvent is 1: (3-5), and preferably 1:4; and the temperature of the stirring for dissolution is 30-80° C., preferably 40-55° C., and more preferably 55° C.

Further, in the above step (3), the temperature of the stirring for reaction is 25-35° C., and preferably 30° C.; and the time of the stirring for reaction is 20-40 min, and preferably 30 min.

An insulating composite layer containing the above-mentioned polyamide adhesive includes, from top to bottom, a first prepreg layer, a substrate and a second prepreg layer in sequence;
where the first prepreg layer and the second prepreg layer are each formed by pre-impregnating a fiber material with the above-mentioned polyamide adhesive, applying glue, and then heat-baking.

Further, the fiber material is glass fiber cloth.

Further, the substrate is a metal foil, and preferably an aluminum foil.

A method for preparing the above insulating composite layer specifically includes the following steps:
(1) pre-impregnating two layers of fiber materials respectively with the above-mentioned polyamide adhesive, applying glue, and heat-baking to obtain the first prepreg layer and the second prepreg layer respectively; and
(2) placing the first prepreg layer and the second prepreg layer on the upper and lower surfaces of the substrate respectively, and performing hot pressing to obtain an insulating composite layer.

Further, in the above step (1), the heat-baking device is an oven; the temperature of the heat-baking is 140-180° C., and preferably 150° C.; and the time of the heat-baking is 1-3 min, and preferably 2 min.

Further, in the above step (2), the hot pressing equipment is a hot press; the temperature of the hot pressing is at 140-170° C., and preferably 160° C.; the time of the hot pressing is 3-5 h, and preferably 4 h. Specifically, the temperature of the hot pressing may be gradually increased from 30-85° C. to 140-170° C. for hot pressing. When the temperature is 30-85° C., the polyamide adhesive attached to the surface of the glass fiber cloth may have a certain fluidity due to heating, and the temperature required for the imidazole curing agent to promote curing is not reached. After a certain period of time, when the temperature rises to 140-170° C., the imidazole curing agent begins to accelerate the reaction, so that the polyamide adhesive is accelerated to cure.

The present disclosure also seeks to protect the use of the polyamide adhesive or the insulating composite layer in preparing a thermal insulation material for liquefied natural gas, especially a shielding layer for a liquefied natural gas ship.

It can be seen from the above technical solutions that compared with the prior art, the beneficial effects of the present disclosure are as follows.
1. The thermal conductivity of the polyamide resin selected in the present disclosure is much lower than that of air, so the thermal insulation performance is better than that of materials containing only air, such as mineral wool, glass fiber and polystyrene. The unique closed-cell property and high gas diffusion resistance of the polyamide resin result in excellent long-term insulation performance thereof. Since the polyamide resin may form hydrogen bonds with water molecules through the amide groups and thus exhibit water absorption, the present disclosure improves this phenomenon by blending it with a bisphenol epoxy resin, an imidazole curing agent and a silane coupling agent. Specifically, since the bisphenol epoxy resin has high adhesion, it can effectively prevent the LNG thermal insulation composite material from cracking in a low temperature environment, thereby avoiding LNG leakage and ensuring the safety of LNG during transportation.
2. The present disclosure modifies the polyamide resin by the structure selection and the using proportion of the raw materials, and simultaneously adjusts the intermolecular force and hydrogen bonding, so that its structure is both rigid and flexible, and the cold and heat shock resistance is improved. The present disclosure introduces bisphenol epoxy resin to increase the flexibility of the molecular chain and improve the low temperature resistance. The present disclosure also uses an imidazole curing agent to open the ring of the bisphenol epoxy resin, so that it is cured and cross-linked to form a network structure, thereby ensuring the low temperature resistance while improving the room-temperature mechanical properties.
3. The polyamide adhesive of the present disclosure contains highly active epoxy groups, hydroxyl groups, and polar groups such as ether bonds, amine bonds, and ester bonds, which are easy to generate van der Waals forces or chemical bonds with the interface of the material, giving the polyamide adhesive excellent bonding strength to polar substrates of such as metals, ceramics, glass, concrete, and wood. After subsequent pre-impregnating, roller extrusion gluing of a glue-coating machine, etc., the polyamide adhesive can be completely attached to the surface of the glass fiber cloth. In addition, the imidazole curing agent can open the ring of the bisphenol epoxy resin, generate a network structure through curing and cross-linking, and form a stable bonding interface on the surface of the glass fiber cloth, so that the product has good bonding strength and chemical resistance.

### DETAILED DESCRIPTION OF EMBODIMENTS

The technical solutions in the embodiments of the present disclosure will be described clearly and completely below. Obviously, the described embodiments are only some of the embodiments of the present disclosure, not all of the embodiments. Based on the embodiments of the present disclosure, all other embodiments obtained by a person ordinarily skilled in the art without creative work fall within the scope of protection of the present disclosure.

In the following embodiments,
1. polyamide resin: Nylon 6, purchased from Shanghai Zhenwei Composite Materials Co., Ltd.;
2. bisphenol epoxy resin: NPEL-128, purchased from Nan Ya Electronic Materials (Kunshan) Co., Ltd.;
3. imidazole curing agent: 2-methylimidazole, purchased from Shanghai Aladdin Biochemical Technology Co., Ltd.;
4. silane coupling agent: 3-aminopropyltriethoxysilane (KBE-90), purchased from Shin-Etsu, Japan;
5. glass fiber cloth: purchased from Nan Ya Electronic Materials (Kunshan) Co., Ltd.; and
6. metal foil: an aluminum foil, purchased from Chalco Materials Application Research Institute Co., Ltd.

### EXAMPLE 1

A polyamide adhesive included the following raw materials by weight: 85 kg of Nylon 6, 15 kg of bisphenol epoxy resin (NPEL-128), 0.01 kg of 2-methylimidazole and 0.1 kg of 3-aminopropyltriethoxysilane (KBE-903).

The preparation method of the polyamide adhesive specifically included the following steps;
(1) weighing each raw material according to the weight of the above-mentioned polyamide adhesive;
(2) placing Nylon 6 in an oven and drying at 100° C. for 2 h, adding into methanol at a mass ratio of 1:4, heating to 55° C. in a reactor and stirring for dissolution, setting up a reflux device, and lowering the temperature to 30° C. after complete dissolution to obtain a polyamide solution; and
(3) adding the bisphenol epoxy resin (NPEL-128), the 2-methylimidazole and the 3-aminopropyltriethoxysilane (KBE-903) into the polyamide solution, adjusting the solid content to 30%, and stirring at a constant temperature of 30° C. for 30 min to obtain the polyamide adhesive.

The insulating composite layer containing the polyamide adhesive included, from top to bottom in sequence, a first prepreg layer, an aluminum foil, and a second prepreg layer, where the first prepreg layer and the second prepreg layer were each formed by pre-impregnating a glass fiber cloth with the above-mentioned polyamide adhesive, applying glue, and then heat-baking.

The method for preparing the above-mentioned insulating composite layer specifically included the following steps:
(1) pouring the above-mentioned polyamide adhesive into an impregnation tank, pre-impregnating two layers of glass fiber cloth respectively with the polyamide adhesive, applying glue, and then putting the impregnated glass fiber cloth in an oven and heat-baking at 150° C. for 2 min to obtain the first prepreg layer and the second prepreg layer respectively; and
(2) placing the first prepreg layer and the second prepreg layer on the upper and lower surfaces of the aluminum foil respectively, putting into a hot press, and performing hot pressing at 160° C. for 4 h to obtain the insulating composite layer.

### EXAMPLE 2

A polyamide adhesive included the following raw materials by weight: 90 kg of Nylon 6, 10 kg of bisphenol epoxy resin (NPEL-128), 0.01 kg of 2-methylimidazole and 0.1 kg of 3-aminopropyltriethoxysilane (KBE-903).

The preparation method of the polyamide adhesive specifically included the following steps:
(1) weighing each raw material according to the weight of the above-mentioned polyamide adhesive;
(2) placing Nylon 6 in an oven and drying at 100° C. for 2 h, adding into methanol at a mass ratio of 1:4, heating to 55° C. in a reactor and stirring for dissolution, setting up a reflux device, and lowering the temperature to 30° C. after complete dissolution to obtain a polyamide solution; and
(3) adding bisphenol epoxy resin (NPEL-128), 2-methylimidazole and 3-aminopropyltriethoxysilane (KBE-903) into the polyamide solution, adjusting the solid content to 30%, and stirring at a constant temperature of 30° C. for 30 min to obtain the polyamide adhesive.

The insulating composite layer containing the polyamide adhesive included, from top to bottom in sequence, a first prepreg layer, an aluminum foil, and a second prepreg layer, where the first prepreg layer and the second prepreg layer were each formed by pre-impregnating a glass fiber cloth with the above-mentioned polyamide adhesive, applying glue, and then heat-baking.

The preparation method of the insulating composite layer specifically included the following steps:
(1) pouring the above-mentioned polyamide adhesive into an impregnation tank, pre-impregnating two layers of glass fiber cloth respectively with the polyamide adhesive, applying glue, and then putting the impregnated glass fiber cloth in an oven and heat-baking at 150° C. for 2 min to obtain the first prepreg layer and the second prepreg layer respectively; and
(2) placing the first prepreg layer and the second prepreg layer on the upper and lower surfaces of the aluminum foil respectively, putting into a hot press, and performing hot pressing at 160° C. for 4 h to obtain the insulating composite layer.

### EXAMPLE 3

A polyamide adhesive included the following raw materials by weight: 80 kg of Nylon 6, 20 kg of bisphenol epoxy resin (NPEL-128), 0.01 kg of 2-methylimidazole and 0.1 kg of 3-aminopropyltriethoxysilane (KBE-903).

The preparation method of the polyamide adhesive specifically included the following steps:
(1) weighing each raw material according to the weight of the above-mentioned polyamide adhesive;
(2) placing Nylon 6 in an oven and drying at 100° C. for 2 h, adding into methanol at a mass ratio of 1:4, heating to 55° C. in a reactor and stirring for dissolution, setting up a reflux device, and lowering the temperature to 30° C. after complete dissolution to obtain a polyamide solution; and
(3) adding bisphenol epoxy resin (NPEL-128), 2-methylimidazole and 3-aminopropyltriethoxysilane (KBE-903) into the polyamide solution, adjusting the solid content to 30%, and stirring at a constant temperature of 30° C. for 30 min to obtain the polyamide adhesive.

The insulating composite layer containing the polyamide adhesive included, from top to bottom in sequence, a first prepreg layer, an aluminum foil, and a second prepreg layer, where the first prepreg layer and the second prepreg layer were each formed by pre-impregnating a glass fiber cloth with the above-mentioned polyamide adhesive, applying glue, and then heat-baking.

The preparation method of the insulating composite layer specifically includes the following steps:
(1) pouring the above-mentioned polyamide adhesive into an impregnation tank, pre-impregnating two layers of glass fiber cloth with the polyamide adhesive, applying glue, and then putting the impregnated glass fiber cloth in an oven and heat-baking at 150° C. for 2 min to obtain the first prepreg layer and the second prepreg layer respectively; and
(2) placing the first prepreg layer and the second prepreg layer on the upper and lower surfaces of the aluminum foil respectively, putting into a hot press, and performing hot pressing at 160° C. for 4 h to obtain the insulating composite layer.

### EXAMPLE 4

A polyamide adhesive included the following raw materials by weight: 70 kg of Nylon 6, 30 kg of bisphenol epoxy resin (NPEL-128), 0.01 kg of 2-methylimidazole and 0.1 kg of 3-aminopropyltriethoxysilane (KBE-903).

The preparation method of the polyamide adhesive specifically included the following steps:
(1) weighing each raw material according to the weight of the above-mentioned polyamide adhesive;
(2) placing Nylon 6 in an oven and drying at 100° C. for 2 h, adding into methanol at a mass ratio of 1:4, heating to 55° C. in a reactor and stirring for dissolution, setting up a reflux device, and lowering the temperature to 30° C. after complete dissolution to obtain a polyamide solution; and
(3) adding bisphenol epoxy resin (NPEL-128), 2-methylimidazole and 3-aminopropyltriethoxysilane (KBE-903) into the polyamide solution, adjusting the solid content to 30%, and stirring at a constant temperature of 30° C. for 30 min to obtain the polyamide adhesive.

The insulating composite layer containing the polyamide adhesive included, from top to bottom in sequence, a first prepreg layer, an aluminum foil, and a second prepreg layer, where the first prepreg layer and the second prepreg layer were each formed by pre-impregnating a glass fiber cloth with the above-mentioned polyamide adhesive, applying glue, and then heat-baking.

The preparation method of the insulating composite layer specifically included the following steps:
(1) pouring the above-mentioned polyamide adhesive into an impregnation tank, pre-impregnating two layers of glass fiber cloth with the polyamide adhesive, applying glue, and then putting the impregnated glass fiber cloth in an oven and heat-baking at 150° C. for 2 min to obtain the first prepreg layer and the second prepreg layer respectively; and
(2) placing the first prepreg layer and the second prepreg layer on the upper and lower surfaces of the aluminum foil respectively, putting into a hot press, and performing hot pressing at 160°° C. for 4 h to obtain the insulating composite layer.

### Comparative Example 1

The only difference from Example 1 was that 2-methylimidazole and 3-aminopropyltriethoxysilane (KBE-903) were not contained.

### Comparative Example 2

The only difference from Example 1 was that 3-aminopropyltriethoxysilane (KBE-903) was not contained.

### Comparative Example 3

The only difference from Example 1 was that 2-methylimidazole was not contained.

### Comparative Example 4

The only difference from Example 1 was that Nylon 6 was replaced by polyamide resin 8061 (purchased from DuPont).

### Comparative Example 5

The only difference from Example 1 was that the bisphenol epoxy resin (NPEL-128) was replaced by a phenol epoxy resin (NPPN-638, purchased from Nan Ya Electronic Materials (Kunshan) Co., Ltd.).

### Comparative Example 6

The only difference from Example 1 was that 2-methylimidazole was replaced by polyetheramine T-403 (purchased from Huntsman).

### Performance Testing

The mechanical properties of the insulating composite layers prepared in Examples 1-4 and Comparative Examples 1-6 were tested respectively, including a peel strength at a room temperature (23°° C.), a peel strength at a low temperature (−170° C.), and a peel strength in seawater (in unit of N/25 mm), for which the test method was Standard EN 1464:2010; and a shear strength (in unit of MPa) and a tensile strength (in unit of N/m), for which the test method was EN ISO 1421, and the instruments used were Japan Shimadzu AGX-100KNV and tensile machine low temperature box TCL-N-T+250 kit.

The results are as shown in Tables 1-3.

TABLE 1
Mechanical Properties of Insulating
Composite Layers of Examples 1-4

| | Example | Example | Example | Example |
|---|---|---|---|---|
| Test item | 1 | 2 | 3 | 4 |
| Peel strength at room | 200-220 | 160-180 | 140-160 | 150-170 |
| temperature (23° C.) | | | | |
| (N/25 mm) | | | | |
| Peel strength at low | 270-280 | 180-200 | 190-210 | 180-190 |
| temperature (−170° C.) | | | | |
| (N/25 mm) | | | | |
| Peel strength in | 180-200 | 130-150 | 100-120 | 100-120 |
| seawater (N/25 mm) | | | | |
| Shear strength (MPa) | 19-22 | 18-20 | 17-19 | 17-19 |
| Tensile strength (KN/m) | 140-180 | 100-120 | 100-120 | 130-150 |

It can be known from Table 1 that the change of the ratio of the polyamide resin to the bisphenol epoxy resin causes the change of the cured and cross-linked network structure of them, thereby affecting the mechanical properties of the insulating composite layer. In the above, Example 1 is the preferred example.

TABLE 2
Mechanical Properties of Insulating Composite
Layers of Comparative Examples 1-3

| | Comparative | Comparative | Comparative |
|---|---|---|---|
| Test item | Example 1 | Example 2 | Example 3 |
| Peel strength at room | Separation | 30-50 | 10-20 |
| temperature (23° C.) | | | |
| (N/25 mm) | | | |
| Peel strength at low | Separation | 60-80 | 60-80 |
| temperature (−170° C.) | | | |
| (N/25 mm) | | | |
| Peel strength in | Separation | Separation | 10-30 |
| seawater (N/25 mm) | | | |
| Shear strength (MPa) | Separation | 5-10 | 5-10 |
| Tensile strength (KN/m) | Separation | 60-80 | 20-50 |

It can be known from Table 2 that in Comparative Example 1, only polyamide resin and bisphenol epoxy resin cannot provide effective bonding strength. In Comparative Examples 2-3, all test data are far less than that of Example 1. This indicates that the polyamide adhesive of the present disclosure requires imidazole curing agent and silane coupling agent to produce a synergistic effect on polyamide resin and bisphenol epoxy resin.

TABLE 3
Mechanical Properties of Insulating Composite
Layers of Comparative Examples 4-6

| | Comparative | Comparative | Comparative |
|---|---|---|---|
| Test item | Example 4 | Example 5 | Example 6 |
| Peel strength at room | 100-120 | 140-160 | 100-120 |
| temperature (23° C.) | | | |
| (N/25 mm) | | | |
| Peel strength at low | 150-170 | Cracking | Cracking |
| temperature (−170° C.) | | | |
| (N/25 mm) | | | |
| Peel strength in | Separation | 100-120 | 30-50 |
| seawater (N/25 mm) | | | |
| Shear strength (MPa) | 10-16 | 17-19 | 10-15 |
| Tensile strength (KN/m) | 100-120 | 100-120 | 80-100 |

It can be known from Table 3 that in Comparative Example 4 which used polyamide resin 8061, the insulating composite layer was directly separated in seawater and cannot effectively resist seawater infiltration. Comparative Examples 5-6 which used phenol epoxy resin and polyetheramine curing agent respectively, the insulating composite layers were not low temperature resistant at −170° C. and directly cracked.

In summary, the polyamide adhesive of the present disclosure has good and stable peel strength, shear strength and tensile strength at the room temperature (23° C.) and low temperature (−170° C.). In addition, the solid content weight (solid content) of the polyamide adhesive of the present disclosure was measured by the standard method GB/T 2793-1995 (Test method for nonvolatile content of adhesives) to be 15%- 30% of the total weight of the polyamide adhesive, so that the polyamide adhesive can be evenly distributed on the glass fiber cloth, enabling that the formed insulating composite layer has balanced and consistent properties in all directions, and is therefore sufficient to be used as a shielding layer for liquefied natural gas ships.

The above description of the disclosed embodiments enables one skilled in the art to implement or use the present disclosure. Various modifications to these embodiments will be apparent to the one skilled in the art, and the general principles defined herein may be implemented in other embodiments without departing from the spirit or scope of the present disclosure. Therefore, the present disclosure will not be limited to the embodiments shown herein, but rather to the widest scope consistent with the principles and novel features disclosed herein.

1. A polyamide adhesive, comprising following raw materials in parts by weight: 70-90 parts of polyamide resin, 10-30 parts of bisphenol epoxy resin, 0.01-0.5 parts of an imidazole curing agent and 0.1-2 parts of a silane coupling agent.

2. The polyamide adhesive according to claim 1, comprising the following raw materials in parts by weight: 85 parts of the polyamide resin, 15 parts of the bisphenol epoxy resin, 0.01 parts of the imidazole curing agent and 0.1 parts of the silane coupling agent.

3. The polyamide adhesive according to claim 1, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

4. A method for preparing the polyamide adhesive according to claim 1, comprising following steps:
(1) weighing each of the raw materials according to the parts by weight of the polyamide adhesive;
(2) adding the polyamide resin into an organic solvent, and stirring for dissolution, to obtain a polyamide solution; and
(3) adding the bisphenol epoxy resin, the imidazole curing agent and the silane coupling into the polyamide solution, and stirring for reaction, to obtain the polyamide adhesive.

5. The method for preparing the polyamide adhesive according to claim 4, wherein in step (2), the organic solvent is methanol; a mass ratio of the polyamide resin to the organic solvent is 1: (3-5); a temperature of the stirring for dissolution is 30-80° C.; and
in step (3), the stirring for reaction is performed at a temperature of 25-35° C. for a time of 20-40 min.

6. An insulating composite layer containing the polyamide adhesive according to claim 1, comprising, from top to bottom, a first prepreg layer, a substrate and a second prepreg layer in sequence; and
the first prepreg layer and the second prepreg layer are each formed by pre-impregnating a fiber material in the polyamide adhesive, applying glue, and then heat-baking.

7. The insulating composite layer according to claim 6, wherein the fiber material is glass fiber cloth and the substrate is a metal foil.

8. A method for preparing the insulating composite layer according to claim 6, comprising
(1) pre-impregnating two layers of the fiber material with the polyamide adhesive, applying glue, and heat-baking to obtain the first prepreg layer and the second prepreg layer respectively; and
(2) placing the first prepreg layer and the second prepreg layer on upper and lower surfaces of the substrate respectively, and performing hot pressing to obtain the insulating composite layer.

9. The method for preparing the insulating composite layer according to claim 8, wherein in step (1), for the heat-baking, a device is an oven, a temperature is 140-180° C., and a time is 1-3 min; and
in step (2), for the hot pressing, a device is a hot press, a temperature is 140-170° C., and a time is 3-5h.

10. The polyamide adhesive according to claim 2, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

11. The method for preparing the polyamide adhesive according to claim 4, comprising the following raw materials in parts by weight: 85 parts of the polyamide resin, 15 parts of the bisphenol epoxy resin, 0.01 parts of the imidazole curing agent and 0.1 parts of the silane coupling agent.

12. The method for preparing the polyamide adhesive according to claim 4, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

13. The method for preparing the polyamide adhesive according to claim 11, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

14. The insulating composite layer according to claim 6, comprising the following raw materials in parts by weight: 85 parts of the polyamide resin, 15 parts of the bisphenol epoxy resin, 0.01 parts of the imidazole curing agent and 0.1 parts of the silane coupling agent.

15. The insulating composite layer according to claim 6, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

16. The insulating composite layer according to claim 14, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

17. The method for preparing the insulating composite layer according to claim 8, comprising the following raw materials in parts by weight: 85 parts of the polyamide resin, 15 parts of the bisphenol epoxy resin, 0.01 parts of the imidazole curing agent and 0.1 parts of the silane coupling agent.

18. The method for preparing the insulating composite layer according to claim 8, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

19. The method for preparing the insulating composite layer according to claim 17, wherein the polyamide resin is Nylon 6;
the imidazole curing agent is at least one selected from the group consisting of 2-methylimidazole, 2-ethylimidazole, 2-phenylimidazole and 2-ethyl-4-methylimidazole; and
the silane coupling agent is 3-aminopropyltriethoxysilane.

20. The method for preparing the insulating composite layer according to claim 8, wherein the fiber material is glass fiber cloth and the substrate is a metal foil.
